(19) United States
(12) Patent Application Publication
(10) Pub. No.: US 2021/0354402 A1
(43) Pub. Date: Nov. 18, 2021

(54) MOLDING SUBSTRATE

(71) Applicant: Japan Vilene Company, Ltd., Tokyo (JP)

(72) Inventor: Tatsuhiko TSUMURA, Shiga (JP)

(73) Assignee: Japan Vilene Company, Ltd., Tokyo (JP)

(21) Appl. No.: 17/321,979

(22) Filed: May 17, 2021

(30) Foreign Application Priority Data
May 18, 2020 (JP) 2020-086689
May 10, 2021 (JP) 2021-079660

(51) Int. Cl. B29C 70/16

(52) U.S. Cl. CPC B29C 70/16; B29K 2223/12

(57) ABSTRACT

The present invention relates to a molding substrate capable of realizing an exterior material for a vehicle from which the attached snow or ice is more easily peeled off. As a result of continuing studies by the applicant of the present application, it has been found that the problem that the adhered snow and ice hardly peels off, which occurs on a molding base material provided with a fiber base layer containing a core-sheath type conjugate fiber in which the sheath portion is a polypropylene-based resin and the core portion is a polyester-based resin, can be solved by adjusting the mass percentage of the core-sheath type conjugate fiber occupying the fiber constituting the fiber base material layer. Specifically, the present inventors have provided a molding substrate which can realize an exterior material such as an exterior material for a vehicle from which adhered snow or ice is easily peeled off, by being a molding substrate having a fiber base layer having a mass percentage of more than 70% by mass.

### CROSS REFERENCE TO RELATED APPLICATIONS

This application claims priority to Japanese Patent Application No. 2020-086689, which was filed on May 18, 2020, and to Japanese Patent Application No. 2021-079660, which was filed on May 10, 2021. The entire contents of each of the prior applications are hereby incorporated by reference herein.

### TECHNICAL FIELD

The present invention relates to a molding substrate, i.e., a base material for molding.

### BACKGROUND ART

For the purpose of reducing the unevenness of the lower surface of the vehicle to suppress the air resistance when traveling, protecting the vehicle from flying stones from the tire and/or reducing road noise, an underbody shield material which is a kind of exterior material in the lower portion of the vehicle (hereinafter, the underbody shield material may be abbreviated as UBS) and/or a wheel house liner material to be mounted on the wheel house of the vehicle body is provided.

As a constituent member of such an exterior material such as UBS or a wheel house liner material, the applicant of the present application has studied a molding substrate provided with a fiber base layer containing a core-sheath type conjugate fiber in which a sheath portion is a polypropylene-based resin and a core portion is a polyester-based resin as described in Japanese Patent Application No. 2019-208366 (Patent literature 1) so far. Note that, in Patent literature 1, the applicant of the present application has described a finding that the higher the mass percentage of the core-sheath type conjugate fiber occupying the fiber constituting the fiber base layer, the more likely it is possible to provide an exterior material having excellent heat resistance, and from this viewpoint, the mass percentage is preferably 50% by mass or more.

### CITATION LIST

### Patent Literature

[Patent literature 1] Japanese Patent Application No. 2019-208366

### SUMMARY OF THE INVENTION

### Technical Problem

However, in the case of exterior materials such as a UBS or a wheel house liner material prepared using a molding substrate satisfying the above-mentioned configuration, snow or ice bounced from the road surface adheres to the surface of the exterior material, and it is sometimes difficult to peel off. Thereafter, the snow or ice as adhered to the exterior material freezes, and/or the snow or ice as adhered to the exterior material freezes due to water or rainwater on the road surface. Then, snow and ice frozen on the exterior material, when peeling off due to strong vibration generated during driving, generates cracks on the surface of the exterior material, and/or internal peeling in the surface of the exterior material, and sometimes causes destruction of the outer material.

In the exterior material thus destroyed, the problem that the expected effects, such as an effect of suppressing the air resistance during driving, an effect of protecting the vehicle body and/or an effect of reducing the road noise, are not satisfactorily exhibited has occurred.

In order to prevent the above-mentioned problems from occurring, there has been a demand for a molding substrate capable of realizing an exterior material such as an exterior material for a vehicle from which attached snow or ice is easily peeled off.

### Solution to Problem

The present inventions are:

[(Claim 1) A molding substrate comprising a fiber base layer, wherein the fiber base layer includes a core-sheath type conjugate fiber in which a sheath portion is a polypropylene-based resin and a core portion is a polyester-based resin, and a mass percentage of the core-sheath type conjugate fiber in the constituent fibers of the fiber base layer is larger than 70% by mass.]

and

[(Claim 2) The molding substrate according to claim 1, wherein the fiber base layer has a portion (a) including one main surface, a portion (b) including the other main surface, and a portion (c) sandwiched between the portion (a) and the portion (b), and the density of the portion (a) is higher than the density of the portion (c).]

### Advantageous Effects of Invention

As a result of continuing studies by the applicant of the present application, it has been found that the problem that the adhered snow and ice hardly peels off, which occurs on a molding base material provided with a fiber base layer containing a core-sheath type conjugate fiber in which the sheath portion is a polypropylene-based resin and the core portion is a polyester-based resin, can be solved by adjusting the mass percentage of the core-sheath type conjugate fiber occupying the fiber constituting the fiber base material layer. Specifically, the present inventors have provided a molding substrate which can realize an exterior material such as an exterior material for a vehicle from which adhered snow or ice is easily peeled off, by being a molding substrate having a fiber base layer having a mass percentage of more than 70% by mass.

Further, as a result of the applicant's continued investigation, it has been found that it is possible to provide a molding substrate capable of realizing an exterior material such as an exterior material for a vehicle from which adhered snow or ice is peeled off more easily, due to the high density of the portion including at least one main surface of the fiber base material layer provided in the molding base material.

As a reason why such an effect is exhibited, solid (snow or ice) or liquid (water or rainwater on the road surface) hardly passes through the part with high density, and therefore, the attached snow, ice and/or water or rainwater on the road surface hardly pass through the part and enter the inside of the fiber base layer. As a result, it is considered that it is possible to provide a molding substrate capable of realizing an exterior material from which the attached snow or ice only stays on the surface of the exterior material and the attached snow or ice is more easily peeled off.

Further, as a molding substrate satisfying the constitution according to the present invention, it is possible to provide a molding substrate which exhibits the secondary effect of being capable of realizing an exterior material which is excellent in sound absorption performance and sound insulation performance and has high stiffness even under a high temperature atmosphere.

### BRIEF DESCRIPTION OF THE DRAWINGS

FIG. 1 is a schematic sectional view of an embodiment of the molding substrate of the present invention.

FIG. 2 is a schematic sectional view of another embodiment of the molding substrate of the present invention.

### DESCRIPTION OF EMBODIMENTS

In the present invention, various configurations such as, for example, the following configurations can be appropriately selected. Incidentally, unless otherwise described and specified, various measurements described in the present invention, were carried out under 25° C. temperature conditions under normal pressure. Then, unless otherwise stated, various measurement results explained in the present invention were obtained by measuring a value that is one order of smaller than the desired value, and the obtained value was rounded to the nearest number to the obtained value. As a specific example, in the case where the first decimal place is the desired value, the second decimal place is obtained by measurement, then the first decimal place is calculated by rounding off the obtained value of the second decimal place, and this value is used as the value to be obtained. Further, each upper limit value and each lower limit value exemplified in the present invention can be arbitrarily combined.

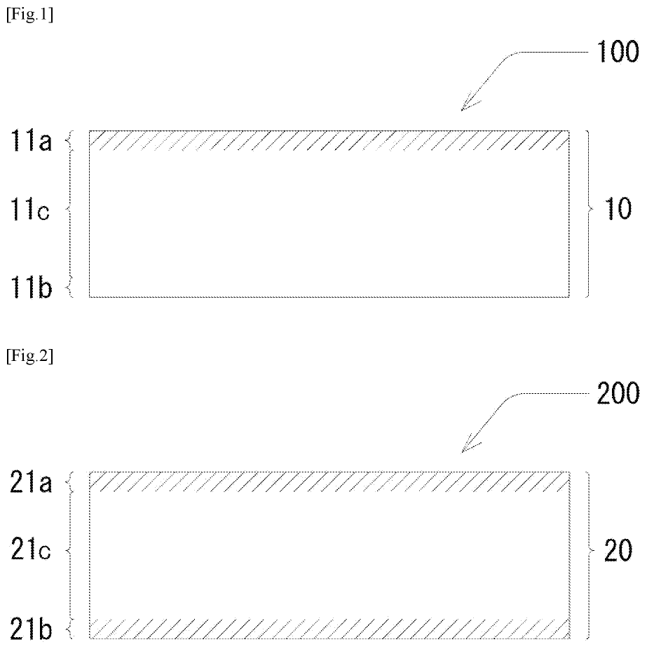

The present invention will be described primarily with reference to FIGS. 1 and 2, which are schematic sectional views of the molding substrate (100, 200) according to the present invention.

The molding substrate (100, 200) includes a fiber base layer (10, 20). Although details will be described later, the molding substrate (100) shown in FIG. 1 has a portion (11a) including one main surface of the fiber base layer (10), a portion (11b) including the other main surface and a portion (11c) sandwiched between the portion (11a) and the portion (11b), and the density of the portion (11a) is higher than the density of the portion (11c). Also, although details will be described later, the molding substrate (200) shown in FIG. 2 has a portion (21a) including one main surface of the fiber base layer (20), a portion (21b) including the other main surface, and a portion (21c) sandwiched between the portion (21a) and the portion (21b), and the densities of the portion (21a) and the portion (21b) are higher than the density of the portion (21c).

The fiber base layer (10, 20) referred to in the present invention refers to a layer of fibers in which fibers are entangled with each other, for example, made of a fiber web, a nonwoven fabric or a fabric such as a woven fabric or a knitted fabric. By including the fiber base layer (10, 20), it is possible to provide a molding substrate (100, 200) which is excellent in moldability because it has high flexibility and is easy to follow a mold or the like. In order to provide a molding substrate (100, 200) which is more excellent in moldability, the fiber base layer (10, 20) constituting the molding substrate (100, 200) are preferably a layer made of a fiber web or a nonwoven fabric in which fibers are randomly entangled with each other, and more preferably only a fiber web or a nonwoven fabric.

The fiber base layer (10, 20) includes a core-sheath type conjugate fiber in which a sheath portion is a polypropylene-based resin and a core portion is a polyester-based resin. By including the core-sheath type conjugate fibers in the fiber base layer (10, 20), it is possible to provide a molding substrate (100, 200) capable of realizing an exterior material from which adhered snow and ice tend to be peeled off.

The type of the polypropylene-based resin constituting the sheath portion of the core-sheath type conjugate fiber according to the present invention may be a well-known one, and for example, polypropylene, polymethylpentene, polypropylene having a structure in which a part of a hydrocarbon is replaced with a nitrile group or a halogen such as fluorine or chlorine, or the like can be employed. Further, the melting point of the polypropylene-based resin can be higher than 80° C., can be higher than 90° C., and can be higher than 100° C.

In addition, the type of the polyester-based resin constituting the core portion of the core-sheath type conjugate fiber according to the present invention may be a well-known one, and for example, polyethylene terephthalate, polytrimethylene terephthalate, polybutylene terephthalate, polyethylene naphthalate, polybutylene naphthalate, polycarbonate, polyarylate, or wholly aromatic polyester resin can be employed. The melting point of the polyester-based resin may be higher than 80° C., may be higher than 90° C., and may be higher than 100° C. Note that the melting point of the polyester-based resin constituting the core portion of the core-sheath type conjugate fiber according to the present invention is higher than of the polypropylene-based resin constituting the sheath portion.

The area ratio of the core portion to the sheath portion in the fiber cross section of the core-sheath type conjugate fiber can be appropriately adjusted, but can be 1:9 to 9:1, 2:8 to 8:2, 3:7 to 7:3, and 4:6 to 6:4.

Various values such as fiber length and fineness of the core-sheath type conjugate fiber are appropriately adjusted so as to be able to provide a molding substrate (100, 200) capable of solving the problem according to the present invention.

The fineness can be 1-100 dtex, can be 1.5-50 dtex, can be 2-30 dtex, and can be 3-10 dtex.

In addition, it can be a fiber having a specific length such as a short fiber, and its fiber length can be 20 to 150 mm, can be 25 to 100 mm, can be 30 to 90 mm, and can be 40 to 80 mm.

It is to be noted that the fiber may be a fiber having a continuous length in which the fiber length is longer than 150 and it is difficult to specify the fiber length (a concept including a constituent fiber of a melt blown nonwoven fabric, a constituent fiber of a spunbond nonwoven fabric, and the like). However, it is preferable that the core-sheath type conjugate fiber is a short fiber so that the molding substrate (100, 200) provided with the main surface portion having a high density can be easily prepared.

Note that the core-sheath type conjugate fiber may be a fiber prepared by kneading a pigment, or a dyed fiber.

The mass percentage of the core-sheath type conjugate fiber according to the present invention occupying the fibers constituting the fiber base layer (10, 20) is larger than 70% by mass, so that it is possible to provide a molding substrate (100, 200) capable of realizing an exterior material from which adhered snow and ice tends to be peeled off easily. The numerical value can be appropriately adjusted as long as it is larger than 70% by mass, can be 75% by mass or more, and is preferably 80% by mass or more. It is to be noted that, when all of the constituent fibers of the fiber base layer (10, 20) are core-sheath type conjugate fibers (the numerical value is 100% by mass), it is more preferable to provide a molding substrate (100, 200) which can realize an exterior material from which adhered snow and ice tends to be peeled off more easily.

Note that, in the present invention, the mass percentage (unit: mass %) of the core-sheath type conjugate fiber occupying the fibers constituting the fiber base layer (10, 20) can be calculated from the following calculation formula.

X=100×B/A
X: The mass percentage of the core-sheath type conjugate fiber occupying the fibers constituting the fiber base layer (10, 20) (unit: mass %)
A: Weight (unit: g/m²) of fiber constituting the fiber base layer (10, 20)
B: Weight (unit: g/m²) of sheath-and-core type conjugate fiber contained in the fiber base layer (10, 20)

It is to be noted that the fibers are extracted from the fiber base layer (10, 20), and the mass of the fiber constituting the fiber base layer (10, 20) and the mass of the core-sheath type conjugate fiber contained in the fiber base layer (10, 20) can be determined using well-known analytical devices and analytical methods such as analysis using various analytical apparatuses such as a melting point meter and a FT-IR, optical analysis using an electron microscope, and dyeing analysis using a Kayastain dyeing or the like. Specifically, 100 fibers are randomly extracted from the fiber base layer (10, 20), and the mass (A) of the 100 fibers is measured. Then, the mass (B) of the core-sheath type conjugate fiber contained in the 100 fibers is measured using the well-known analysis apparatus and analysis method described above.

Alternatively, 5 g (mass (A)) of fibers are randomly extracted from the fiber substrate layer (10, 20). Then, the mass (B) of the core-sheath type conjugate fiber contained in the 5 g of the fibers is measured by using the well-known analyzer and the analysis method described above.

From each mass thus determined, it is possible to determine the mass percentage (X) of the core-sheath type conjugate fiber occupying the fibers constituting the fiber base layer (10, 20)

In addition, when the manufacturing process is known, it is possible to determine the mass of the fiber constituting the fiber base layer (10, 20) and the mass of the core-sheath type conjugate fiber contained in the fiber base layer (10, 20) by confirming the respective types and the respective masses of fibers blended for preparing the fiber base layer (10, 20).

It is preferable that the core-sheath type conjugate fibers are uniformly distributed and present in the fiber base layer (10, 20). Specifically, it is preferable that the mass percentage (X) of the portion (11a, 21a) including one main surface of the fiber base material layer (10, 20), the mass percentage (X) of the portion (11b, 21b) including the other main surface of the fiber base layer (10, 20), and the mass percentage (X) of the portion (11c, 21c) sandwiched between both portions (11a and 11b, 21a and 21b) of the fiber base layer (10, 20) have the same value. The fiber base layer (10, 20) of such a mode is preferable because it can provide a molding substrate (100, 200) that can more efficiently realize an exterior material from which attached snow or ice is easily peeled off.

In addition to the core-sheath type conjugate fiber, the fiber base layer (10, 20) may contain other organic fibers composed of one kind of organic resin, other organic fibers composed of a plurality of kinds of organic resins, and inorganic fibers such as glass fibers.

As such other organic fibers, for example, a polyolefin-based resin (e.g., polyethylene, polypropylene, polymethylpentene, a polyolefin-based resin having a structure in which a part of a hydrocarbon is replaced with a halogen such as nitrile group or fluorine or chlorine), a styrene-based resin, a polyether-based resin (e.g., polyether ether ketone, a modified polyphenylene ether, an aromatic polyether ketone, or the like), a polyester-based resin (e.g., polyethylene terephthalate, polybutylene terephthalate, polyethylene naphthalate, polybutylene naphthalate, polycarbonate, polyarylate, wholly aromatic polyester resins, polyamide-imide resins, polyamide-based resins (e.g., aromatic polyamide resins, aromatic polyether amide resins, nylon resins, etc., Resins having a ditrile group (e.g., polyacrylonitrile, etc.), urethane-based resins, epoxy-based resins, polysulfone-based resins (e.g., polysulfone, polyether sulfone, etc.), fluorine-based resins (e.g., polytetrafluoroethylene, polyvinylidene fluoride, etc.), cellulose-based resins, polybenzimidazole resins, acrylic resins (e.g., polyacrylonitrile-based resins obtained by copolymerizing acrylic esters or methacrylic esters, etc., modacrylic resins obtained by copolymerizing acrylonitrile with vinyl chloride or vinylidene chloride, etc.) and the like can be mentioned, and can be constituted using a known organic resin.

Note that these organic resins may be made of any of a linear polymer or a branched polymer, and the organic resin may be a block copolymer or a random copolymer, and there is no particular limitation on the presence or absence of the steric structure or crystallinity of the organic resin. Further, it may be a mixture of multi-component organic resins.

Further, these organic resins may contain additives such as, for example, a flame retardant, a perfume, a pigment, an antibacterial agent, an antifungal material, a photocatalyst particulate, an emulsifier, a dispersant, a surfactant, particles to be subjected to heating and foamed, inorganic particles, and an antioxidant.

The fibers constituting the fiber base layer (10, 20) may contain a deformed cross section fiber in addition to a substantially circular fiber or an oval fiber. Incidentally, the irregular cross-section fiber may be a fiber having a fiber cross section such as, hollow shape, polygonal shape such as a triangular shape, alphabet character-type shape such as a Y-shape, irregular shape, multileaf shape, symbol-type shape such as an asterisk shape, or a shape to which a plurality of these shapes are combined.

The fiber base layer (10, 20) can be prepared, for example, by a dry method in which fibers are entangled by subjecting fibers to a card device, an air lay device, or the like, a wet method in which fibers are dispersed in a solvent and the papermaking fibers are entangled in a sheet form, a direct spinning method (a melt blowing method, a spunbond method, an electrostatic spinning method, a method in which a spinning raw liquid and a gas flow are discharged in parallel and spun (for example, a method disclosed in JP 2009-287138) and the like) is used to spin fibers and collect them, and the like.

In addition, the constituent fibers can be entangled and/or integrated. As a method of entangling and/or integrating the constituent fibers together, for example, a method of entangling by a needle or a water flow, a method of bonding and integrating the constituent fibers together by a binder or an adhesive fiber by subjecting the fiber web to a heat treatment, or the like can be mentioned.

The method of the heat treatment can be selected as appropriate; for example, a method of heating or pressurizing with heat by a roll, a method of heating by oven dryer, a far-infrared heater, a dry heat dryer, or a hot air dryer, or a method of heating by irradiating infrared rays under no pressure, or the like can be used.

In order to bond the constituent fibers of the fiber base layer (10, 20), a binder may be used. The type of binder which can be used is appropriately selected, for example, polyolefin (modified polyolefin or the like), ethylene-acrylate copolymer such as ethylene-vinyl alcohol copolymer, various rubbers and derivatives thereof (styrene-butadiene rubber (SBR), fluororubber, ethylene-propylene-diene rubber (EPDM) or the like), cellulose derivatives (carboxy methylcellulose (CMC), hydroxyethylcellulose, hydroxypropylcellulose, or the like), polyvinyl alcohol (PVA), polyvinyl butyral (PVB), polyvinylpyrrolidone (PVP), Epoxy resins, polyvinylidene fluoride (PVdF), vinylidene fluoride-hexafluoropropylene copolymers (PVdF-HFP), acrylic ester resins (such as acrylonitrile styrene copolymer resins), polyurethane resins, and the like can be used.

However, it is preferable to use a fiber base layer (10, 20) which is not provided with a binder so as to be able to prepare a molding substrate (100, 200) in which the effect according to the present invention is exhibited as intended.

Further, a fiber base layer (10, 20) can be prepared using a woven fabric or a knitted fabric prepared by weaving or knitting the above-described fibers. It is to be noted that a fabric such as a woven fabric or a knitted fabric may be subjected to a method of entangling and/or integrating the above-described constituent fibers with each other to prepare a fiber base layer (10, 20)

Various configurations of the fiber base layer (10, 20), such as, for example, thickness and basis weight, are not particularly limited and are appropriately adjusted. The thickness can be 0.2-15 mm, 0.3-10 mm, and 1-3 mm. The weight can also be, for example, 30 to 2000 g/m², and can be 40 to 1500 g/m². In particular, the molding substrate (100, 200) having the fiber base layer (10, 20) having the basis weight larger than 800 g/m² is preferable to be excellent in bending strength and tensile strength in a high-temperature atmosphere, and more preferable to be a molding substrate (100, 200) having the fiber base material layer (10, 20) having the basis weight of 900 g/m² or more. Incidentally, the thickness in the present invention refers to the vertical length when applying 20 g/cm² compressive load to the vertical direction to the main surface, and the basis weight in the present invention refers to weight per 1 m² in the surface having the widest area of the measured object (main surface).

In another aspect of the present invention, the fiber base layer (10, 20) has a portion (11a, 21a) including one main surface, a portion (11b, 21b) including the other main surface, and portion (11c, 21c) sandwiched between the portion (11a, 21a) and the portion (11b, 21b), and is characterized in that at least the density of the portion (11a, 21a) is higher than the density of the portion (11c, 21c).

The fiber base layer (10, 20) according to the present invention satisfy the above-mentioned configuration, whereby it is possible to provide a molding substrate (100, 200) capable of realizing an exterior material from which attached snow or ice is easily peeled off.

The reason is that the solid (snow or ice) or the liquid (water or rainwater on the road surface) does not easily pass through the portion (11a, 21a) having high density, so that the attached snow or ice and the water or rainwater on the road surface do not easily pass through the portion (11a, 21a) and enter the inside (11c, 21c) of the fiber base layer (10, 20).

As a result, it is considered that the molding substrate (100, 200) capable of realizing the exterior material from which the attached snow or ice only stays on the surface of the exterior material and the attached snow or ice is easily peeled off can be provided.

Incidentally, the main surface of the portion (11a, 21a) side in the molding substrate (100, 200), when used as an exterior material, it is preferably faced toward the side where snow or ice or water or rainwater adheres.

In addition, the fiber base layer (10, 20) satisfying the constitution according to the present invention can provide the molding substrate (100, 200) characteristic a secondary effect of being capable of realizing an exterior material having excellent sound absorbing performance, sound insulating performance and exhibiting high stiffness even in a high temperature atmosphere.

The density of the portion (11a, 21a) including one main surface of the fiber base layer (10, 20), the density of the portion (11b, 21b) including the other main surface, and the density of the portion (11c, 21c) sandwiched between the portion (11a, 21a) and the portion (11b, 21b) can be confirmed by the following comparison method.

### (Comparison Method of Density)

1. An electron micrograph of a cross section in the thickness direction of the fiber base layer (10, 20) constituting the molding substrate (100, 200) is taken.
At this time, the photographing magnification is adjusted so that the entire thickness direction of the fiber base layer (10, 20) is displayed in the electron micrograph.
2. On an electron micrograph, drawing a line segment connecting from one main surface (e.g., the main surface present on the upper side of the paper in FIGS. 1, 2) to the other main surface (e.g., the main surface present on the lower side of the paper in FIGS. 1, 2), at the shortest distance with parallel to the thickness direction of the molding substrate(100, 200).
3. Draw two straight lines (A1, A2) that pass through the end point of the line segments and form a vertical to the line segment, on the electron micrograph.
In addition, two straight lines (B1, B2) are drawn as a vertical to the line segment and so as to divide the line segment into three equal segments.
4. A range sandwiched between the straight line (A1) and a straight line (B1) which divides the line segment into three equal parts and which is located at a position closest to the straight line (A1) is defined as a “range a”.
5. A range sandwiched between the straight line (A2) and a straight line (B2) which divides the line segment into three equal parts and which is located at a position closest to the straight line (A2) is defined as a “range b”.
6. A range sandwiched between the straight lines B1 and B2 is defined as a “range c”.
7. Calculate the percentage(a) of an area of a component constituting a fiber base layer (10, 20) such as a fiber or a binder in cross-sectional area of fiber substrate layer (10, 20) reflected in “range a”.
8. Calculate the percentage(b) of an area of a component constituting a fiber base layer (10, 20) such as a fiber or a binder in cross-sectional area of fiber substrate layer (10, 20) reflected in “range b”.
9. Calculate the percentage(c) of an area of a component constituting a fiber base layer (10, 20) such as a fiber or a binder in cross-sectional area of fiber substrate layer (10, 20) reflected in “range c”.

When the percentage(a) is higher than the percentage(c), which is calculated as described above, the density of the portion (11a, 21a) including one main surface in the fiber base layer (10, 20) can be determined to be higher than the density of the portion (11c, 21c) sandwiched between the portion (11a, 21a) and the portion (11b, 21b) including the other main surface.

When both the percentage(a) and the percentage(b) are higher than the percentage(c), which is calculated as described above, the density of the portion (11a, 21a) including one main surface in the fiber base layer (10, 20) and the portion (11b, 21b) including another main surface in the fiber base layer (10, 20) are higher than the density of the density of the portion (11c, 21c) sandwiched between the portion (11a, 21a) and the portion (11b, 21b).

In the molding substrate (100) according to the present invention, as illustrated in FIG. 1, only a portion (11a) including one main surface of the fiber base layer (10) may be a dense portion. With the molding substrate (100) provided with the fiber base layer (10) in such a manner, it is possible to provide the molding base material (100) which more effectively exhibits the secondary effect of being able to realize an exterior material having more excellent sound absorbing performance, sound insulating performance, and stiffness.

As shown in FIG. 2, in another molding substrate (200) according to the present invention, in addition to the portion (21a) including one main surface of the fiber base layer (20), the other main surface (a main surface on the lower side on the paper in FIG. 2) facing the portion (21a) may also be a dense portion. With the molding substrate (200) provided with the fiber base layer (20) in such a manner, it is possible to provide the molding substrate (200) which more effectively exhibits the secondary effect of being able to realize an exterior material having more excellent sound absorbing performance, sound insulating performance, and stiffness.

The method of forming the portion (11a, 21a, 21b) including the main surface having a high density on the fiber base layer (10, 20) is appropriately adjusted. For example, a method of densifying the portion including the main surface by applying heat or heat and pressure by a heat roll to the main surface of the fabric, a method of densifying the portion including the main surface by applying heat or heat and pressure by applying a heat roll to the main surface of the fabric so that the portion including the main surface melted into a porous film shape, a method of densifying the portion including the main surface by applying a binder or an additive to the main surface of the fabric, a method of densifying the portion including the main surface by applying a hydroentangling treatment or a needle punching treatment to the main surface of the fabric to increase the fiber density, and the like can be mentioned.

In particular, it is preferable that a portion (11a, 21a, 21b) containing a main surface having a high density is formed by melting the sheath portion of the core-sheath type conjugate fiber constituting the main surface. In the main surface, a part of the void existing in the main surface is closed by the molten sheath portion, the air permeability is lowered and the density is increased, and moreover, in the main surface, the molten sheath portion is in the form of a porous film, the air permeability is lowered and the density is increased, so that it is possible to provide a molding substrate (100, 200) which more effectively exhibits a side effect of being able to realize an exterior material which is superior in sound absorbing performance, sound insulating performance, and stiffness.

The densified portion of the fiber base layer (10, 20) is a part of reduced air permeability.

When lowering the air permeability and increasing the density of the part including the main surface, it is preferable to apply heat and pressure simultaneously. In the case where only heat is applied without applying pressure to the main surface of the fabric, the portion including the main surface may not be sufficiently densified. Further, even if heat and pressure are applied to the main surface of the fabric by applying a heating roll to the main surface of the fabric after only heat is applied to the main surface of the fabric, the portion containing the main surface may remain in a state of not being sufficiently densified.

As a result, it may be difficult to provide the molding substrate (100, 200) having excellent sound absorption characteristics (specifically, sound absorption characteristics in a frequency band of less than 2000 Hz).

Therefore, in the heat treatment for reducing the air permeability and densifying of the portion containing the main surface, it is more preferable to first apply heat and pressure to the fabric at the same time.

The thickness of the molding substrate (100, 200) may be 20 mm or less, 10 mm or less, and 5 mm or less. On the other hand, although the lower limit value of the thickness is appropriately adjusted, it is practical that the thickness is 0.5 mm or more. The weight of the molding substrate (100, 200) is selected as appropriate, but may be less than or equal to 2000 g/m², and may be less than or equal to 1500 g/m². On the other hand, although the lower limit of the basis weight is appropriately adjusted, it is realistic is 10 g/m² or more, preferably 50 g/m² or more, is preferably 100 g/m² or more.

The molding substrate (100, 200) of the present invention may be provided with a cover material such as a further porous body, a film, or a foam. The type of the cover material may be appropriately selected depending on the physical properties required for the molding substrate, and may be, for example, a fabric, a porous film or a non-porous film, a porous foam or a non-porous foam. Various configurations such as the basis weight, thickness, and porosity of the cover material can be appropriately selected depending on the required physical properties. In particular, it is preferable to be a spunbond nonwoven fabric because it is easy to provide a molding substrate, which can realize an exterior material from which adhered snow and ice tend to be peeled off easily. Further, since it is easy to provide a molding substrate capable of realizing an exterior material from which attached snow or ice is easily peeled off, it is preferable to be a molding substrate (100, 200) provided with a spunbond nonwoven fabric on both main surfaces.

The method of providing the cover material on the molding substrate (100, 200) can be appropriately selected, but can be a mode in which they are bonded and integrated by a binder, a mode in which the main surfaces of the molding substrate (100, 200) are melted and the cover material is laminated by bonding a component consisting the main surface (for example, a sheath portion of a core-sheath type conjugate fiber), a mode in which the main surface of the cover material is melted and laminated with a molding substrate (100, 200) to be bonded by the components constituting the main surface, or the like.

The molding substrate may have a print layer on its main surface or a top coat layer on the print layer. The printed layer refers to a layer of a resin which is present on at least one main surface of a molding substrate and is mainly responsible for improving designability and/or feel of the molding substrate. In addition to the resin, the print layer may contain an additive described above. Note that the molding substrate may have only one type of print, or may have a plurality of types of prints having different formulations such as the type of resin, constitution of the print and the type or presence or absence of the pigment. Its existence mode can also be appropriately adjusted, but can be a mode in which the print is on the entire main surface, or a mode in which the print is partially on the main surface.

Further, the topcoat layer refers to a layer of a resin which is present on at least one main surface of a molding substrate and is mainly responsible for protecting a main surface of a molding substrate. In addition to the resin, the topcoat layer may contain an additive described above. Note that the molding substrate may have only one kind of topcoat, or may have a plurality of kinds of topcoats having different blending such as the type of resin constituting the topcoat. Its existence mode can also be appropriately adjusted, but can be a mode in which the topcoat is on the entire main surface, or a mode in which the topcoat is partially on the main surface.

The type of the resin constituting the print and the topcoat layer can be appropriately selected, and the same resin as that of the binder described above can be employed. In particular, it is preferable to include an acrylic resin because it is softened to an appropriate at the time of thermoforming such as a heat press using a mold, so that a molding substrate which follows the mold and is excellent in moldability can be provided.

### EXAMPLES

Hereinafter, the present invention will be specifically described by way of Examples, but these do not limit the scope of the present invention. Note that the molding substrate prepared in the examples and comparative examples was subjected to the following evaluation method to confirm its physical properties.

### (Method for Evaluating Ice Release Property)

A square-shaped sample (150 mm on one side) was taken from the molding substrate, and an icing force test equipment was installed on one main surface of the sample or on the other main surface of the sample. The icing force testing equipment was a cylindrical jig (outer diameter: 48.6 mm, inner diameter: 44 mm, height: 30 mm, thickness: 2.3 mm, ring portion is on the outer peripheral surface) prepared by using a material of STK500 disclosed in JIS G3444:2015, and was installed so that the end portion of the cylinder faces the main surface of the sample. In addition, when the molding substrate was provided with a main surface derived from a spunbond nonwoven fabric, it was installed so that an end portion of the cylinder faced the main surface of the sample.

Then, it was left at the test chamber (−15° C.) for 1 hour or more while the main surface on the side, where the icing force test equipment was installed, faced to the side opposite to the direction of gravity.

While left in the test chamber, 5 ml of distilled water (3° C.) was injected into the inside of the ice accretion force test equipment, and they were left for 15 minutes to freeze the distilled water. After icing, in addition, 5 ml of distilled water (3° C.) was injected into, and they were left for freeze the distilled water. After freezing for 30 minutes, in addition, 5 ml of distilled water (3° C.) was injected into, and they were left for 30 minutes to freeze the distilled water. Then, 15 ml of distilled water (3° C.) was injected into, and they were left for freeze the distilled water.

Thereafter, while keeping the sample fixed, a force gauge with a 500 mm wire was applied to the ring portion of the icing force test equipment, and the wire was pulled up to the opposite side of the gravity direction until the icing force test equipment peeled off from the sample.

The maximum value of the peeling strength measured until the icing force test equipment peeled off from the sample was 25 N or less, which was evaluated as “O” as a molding substrate excellent in ice peeling property, and the value higher than 25 N was evaluated as “X” as a molding substrate inferior in ice peeling property.

(Method for Evaluating Bending Strength under High-Temperature Atmosphere)

Using a test equipment described in the method for determining the bending characteristics of plastics in a JIS K7171 at 80° C., a sample (length: 150 mm, width: 50 mm) taken from the molding substrate was left for 1 hour under an atmosphere of 80° C. was placed at a distance of 100mm between fulcrums, and an indenter with a tip radius of 5 mm was loaded at a speed of 50 mm/min with respect to the center between fulcrums. The maximum point load was obtained from the load and deflection at this time as the thermal bending stiffness values.

Thermal bending stiffness values obtained by measuring, 10 N/50 mm or more was evaluated as “O” as excellent flexural strength under a high temperature atmosphere, less than 10 N/50 mm was evaluated as “x” as inferior flexural strength under a high temperature atmosphere.

### (Method of Evaluating Tensile Strength)

A sample taken from the molding substrate was sampled into a dumbbell No. 1 shape described in JIS K6251, and attached to a tensile measuring equipment so as to be 90 mm between chucks. Then, the maximum point load was measured at a tensile speed of 200 mm/min, to determine the tensile strength.

Tensile strength obtained by measuring, 285 N/cm or more was evaluated as “O” as excellent tensile strength, less than 285 N/cm was evaluated as “x” as inferior tensile strength.

### (Method of Evaluating Sound Absorption)

Samples taken from the molding substrate were subjected to a normal incident sound absorption coefficient measuring equipment made by Bruel & Kjaer Co., and the normal incident sound absorption coefficient compliant with ISO354 was measured in the frequency range of 500 Hz to 6300 Hz. Incidentally, when the measurement of the sound absorption coefficient, when setting the molding substrate to a small acoustic tube for high frequency, provided an air layer behind the molding substrate when viewed from the sound source side, the sum of thickness of the molding substrate (diameter: 28 mm, thickness: 5 mm) and the air layer was 15 mm. In addition, when the molding substrate was provided with a main surface derived from a spunbond nonwoven fabric, measurement was performed so that the main surface was exposed to the generation side of sound waves.

With respect to the measured molding substrate, having a sound absorption coefficient of 40% or more at 1000 kHz, having a sound absorption coefficient of 55% or more at 1600 Hz, and having a sound absorption coefficient of 65% or more at 2000 Hz were evaluated as “O” as excellent sound absorption properties. Further, those lower than the sound absorption coefficient described above, was evaluated as “x” as inferior sound absorption properties.

### (Types of Fibers Used)

The core-sheath type conjugate fiber (fineness: 4.4 dtex, fiber length: 51 mm, core portion: polyethylene terephthalate (melting point: 258° C.), sheath portion: polypropylene (melting point: 163° C.)): and thereafter, is referred to as a PET/PP core-sheath type conjugate fiber.
Polyethylene terephthalate fiber 1 (fineness: 6.6 dtex, fiber length:76 mm, melting point: 258° C.): hereinafter, referred to as PET staple fiber.
Polyethylene terephthalate fiber 2 (fineness: 4.4 dtex, fiber length: 51 mm, core portion: polyethylene terephthalate (melting point: 258° C.), sheath portion: low melting point polyethylene terephthalate (melting point: 163° C.)): Thereafter, it is referred to as a PET/Lo-PET core-sheath type conjugate fiber.

### Example 1

Fiber webs were prepared by subjecting PET/PP sheath-core type conjugate fibers to a curding machine. Then, a needle punched web was prepared by a needle punching process which was performed from one main surface of the fiber web toward the other main surface.

The needle punched web was subjected to a heated roll whose heating temperature was adjusted to 190° C., and the heated roll was applied to both main surfaces of the needle punched web to apply heat and pressure simultaneously. The nonwoven fabric thus prepared was used as a base material (a basis weight:1200 g/m², a thickness: 12 mm). Further, a molding substrate (a basis weight:1200 g/m², a thickness: 5 mm) was prepared by supplying the base material to a far-infrared heating oven whose heating temperature was adjusted to 210° C. heating it, and then molding it using a cold press device.

The portion (corresponding to 21a, 21b in FIG. 2) of the molding substrate including both main surfaces were porous film-like and densified by melting of the sheath portion, and were both higher in density than the portion (corresponding to 21c in FIG. 2) sandwiched between said portions.

### Example 2

Two spunbond nonwoven fabrics made of polyethylene terephthalate resins (basis weight: 35 g/m²) were prepared.

The above-mentioned each spunbonded nonwoven fabrics were superposed on both main surfaces of the needle punched web prepared in Example 1, and subjected to a heated roll adjusted to a heating temperature of 190° C., and heat and pressure were simultaneously applied to both main surfaces of the needle punched web through the spunbonded nonwoven fabrics by using the heated roll to obtain a base material (a basis weight: 1270 g/m², a thickness: 12 mm). Further, a molding substrate (a basis weight:1270 g/m², a thickness: 5 mm) was prepared by supplying the base material to a far-infrared heating oven whose heating temperature was adjusted to 210° C. heating it, and then molding it using a cold press device.

The portion (corresponding to 21a, 21b in FIG. 2) including both main surfaces of the fiber base layer derived from the needle punched web were porous film-like and densified by melting of the sheath portion same manner as in Example 1, and were both higher in density than the portion (corresponding to 21c in FIG. 2) sandwiched between said portions.

### Example 3

A fiber web was prepared by mixing 80% by mass of a PET/PP core-sheath type conjugate fiber and 20% by mass of a PET staple fiber, and subjecting the mixture to a curding machine. A molding substrate (a basis weight: 1270 g/m², a thickness: 5 mm) was prepared in the same manner as in Example 2 except that the fiber web thus prepared were used.

The portion (corresponding to 21a, 21b in FIG. 2) including both main surfaces of the fiber base layer derived from the needle punched web were porous film-like and densified by melting of the sheath portion although not as much as in Examples 1 to 2, and were both higher in density than the portion (corresponding to 21c in FIG. 2) sandwiched between said portions.

### Comparative Example 1

A fiber web was prepared by mixing 70% by mass of a PET/PP core-sheath type conjugate fiber and 30% by mass of a PET staple fiber, and subjecting the mixture to a curding machine. A molding substrate (a basis weight: 1270 g/m², a thickness: 5 mm) was prepared in the same manner as in Example 2 except that the fiber web thus prepared were used.

The portion (corresponding to 21a, 21b in FIG. 2) including both main surfaces of the fiber base layer derived from the needle punched web were porous film-like and densified by melting of the sheath portion although not as much as in Examples 1 to 3, and were both higher in density than the portion (corresponding to 21c in FIG. 2) sandwiched between said portions.

### Comparative Example 2

A molding substrate (a basis weight: 1270 g/m², a thickness: 5 mm) was prepared in the same manner as in Example 2 except that a PET/Lo-PET core-sheath type conjugate fiber was used instead of PET/PP core-sheath type conjugate fiber.

The portion (corresponding to 21a, 21b in FIG. 2) including both main surfaces of the fiber base layer derived from the needle punched web were porous film-like and densified by melting of the sheath portion same manner as in Example 1, and were both higher in density than the portion (corresponding to 21c in FIG. 2) sandwiched between said portions.

In Examples 2 to 3 and Comparative Examples 1 to 2, the needle punched web and the spunbond nonwoven fabrics were fiber-bonded by the melted sheath component.

The evaluation results of the constitution and various physical properties of the molding substrate prepared as described above were summarized in Table 1. For items not provided, “-” is indicated in the table.

TABLE 1

| | | | | | Comparative | Comparative |
|---|---|---|---|---|---|---|
| | | Example 1 | Example 2 | Example 3 | Example 1 | Example 2 |
| a cover material on one | basis weight (g/cm²) | — | 35 | 35 | 35 | 35 |
| main surface side | | | | | | |
| (derived from a spunbond | | | | | | |
| nonwoven fabric) | | | | | | |
| a fiber base layer | PET/PP core-sheath type | 100 | 100 | 80 | 70 | — |
| | conjugate fiber | | | | | |
| | (% by mass) | | | | | |
| | PET staple fiber | — | — | 20 | 30 | — |
| | (% by mass) | | | | | |
| | PET/Lo-PET core-sheath | — | — | — | — | 100 |
| | type conjugate fiber | | | | | |
| | (% by mass) | | | | | |
| | basis weight | 1200 | 1200 | 1200 | 1200 | 1200 |
| | (g/cm²) | | | | | |
| a cover material on the | basis weight (g/cm²) | — | 35 | 35 | 35 | 35 |
| other main surface side | | | | | | |
| (derived from a spunbond | | | | | | |
| nonwoven fabric) | | | | | | |
| Ice Release Property | | ◯ | ◯ | ◯ | × | × |
| Bending Strength under High-Temperature Atmosphere | | ◯ | ◯ | ◯ | × | × |
| Tensile Strength | | ◯ | ◯ | ◯ | ◯ | ◯ |
| Sound Absorption | 1000 Hz | ◯ | ◯ | ◯ | × | ◯ |
| | 1600 Hz | ◯ | ◯ | ◯ | × | ◯ |
| | 2000 Hz | ◯ | ◯ | ◯ | ◯ | ◯ |

Since the molding substrates of Examples 1 to 3 satisfying the constitution of the present invention were excellent in ice peeling property, and they were molding substrates capable of realizing an exterior material from which attached snow and ice easily peel off. Furthermore, since the molding substrate was excellent in bending strength, tensile strength, and sound absorption under a high temperature atmosphere, so that the molding substrate was capable of realizing an exterior material having high stiffness and excellent sound absorption performance. On the other hand, since the molding substrate of Comparative Examples 1 to 2 which does not satisfy the configuration of the present invention was inferior in ice peeling property, so that the molding substrate was not capable of realizing an exterior material having high stiffness and excellent sound absorption performance.

In addition, from the results of comparing of Example 2 and Comparative Example 2, the molding substrate according to the present invention was provided with a fiber base layer containing the core-sheath type conjugate fiber in which a sheath portion is a polypropylene-based resin and a core portion is a polyester-based resin, and therefore, it is also possible to exhibit a high stiffness even under a high temperature atmosphere by being rich in bending strength under a high temperature atmosphere, and it was a molding substrate capable of realizing an exterior material from which attached snow and ice easily peel off.

Furthermore, from the results of comparing Examples 2 to 3 and Comparative Example 1, the molding substrate according to the present invention was provided with a fiber base layer containing the core-sheath type conjugate fiber which occupies more than 70% by mass in the constituent fibers of the fiber base layer, and therefore, it is also possible to exhibit a high stiffness even under a high temperature atmosphere by being rich in bending strength under a high temperature atmosphere, and it was a molding substrate capable of realizing an exterior material from which attached snow and ice easily peel off.

### Example 4

A molding substrate (a basis weight: 870 g/m², a thickness: 5 mm) was prepared in the same manner as in Example 2 except that a lightened fiber web was used.

### Example 5

A molding substrate (a basis weight: 970 g/m², a thickness: 5 mm) was prepared in the same manner as in Example 2 except that a lightened fiber web was used.

### Example 6

One spunbond nonwoven fabric (basis weight: 35 g/m²) made of polyethylene terephthalate resins was prepared.

The above-mentioned spunbonded nonwoven fabric was superposed on one main surfaces of the needle punched web prepared in Example 1, and subjected to a heated roll adjusted to a heating temperature of 190° C., and heat and pressure were simultaneously applied to both main surfaces of the needle punched web through the spunbonded nonwoven fabric by using the heated roll to obtain a base material (a basis weight:1235 g/m², a thickness: 12 mm). Further, a molding substrate (a basis weight:1235 g/m², a thickness: 5 mm) was prepared by supplying the base material to a far-infrared heating oven whose heating temperature was adjusted to 210° C. to heat it, and then molding it using a cold press device.

In Examples 4 to 6, the portion (corresponding to 21a, 21b in FIG. 2) including both main surfaces of the fiber base layer derived from the needle punched web were porous film-like and densified by melting of the sheath portion same manner as in Example 2, and were both higher in density than the portion (corresponding to 21c in FIG. 2) sandwiched between said portions. Then, the needle punched web and each spunbond nonwoven fabric were fiber-bonded by the melted sheath component.

The evaluation results of the constitution and various physical properties of the molding substrate prepared as described above were summarized in Table 2. For items not provided, “-” is written in the table. In order to facilitate understanding, the results of Example 2 are also described.

TABLE 2

| | | Example 4 | Example 5 | Example 2 | Example 6 |
|---|---|---|---|---|---|
| a cover material on one | basis weight (g/cm²) | 35 | 35 | 35 | 35 |
| main surface side | | | | | |
| (derived from a | | | | | |
| spunbond nonwoven fabric) | | | | | |
| a fiber base layer | PET/PP core-sheath type | 100 | 100 | 100 | 100 |
| | conjugate fiber | | | | |
| | (% by mass) | | | | |
| | PET staple fiber | — | — | — | — |
| | (% by mass) | | | | |
| | PET/Lo-PET core-sheath type | — | — | — | — |
| | conjugate fiber | | | | |
| | (% by mass) | | | | |
| | basis weight | 800 | 900 | 1200 | 1200 |
| | (g/cm²) | | | | |
| a cover material on the other | basis weight (g/cm²) | 35 | 35 | 35 | — |
| main surface side | | | | | |
| (derived from a | | | | | |
| spunbond nonwoven fabric) | | | | | |
| Ice Release Property | | ∘ | ∘ | ∘ | ∘ |
| Bending Strength under High-Temperature Atmosphere | | x | ∘ | ∘ | ∘ |
| Tensile Strength | | x | ∘ | ∘ | ∘ |
| Sound Absorption | 1000 Hz | ∘ | ∘ | ∘ | ∘ |
| | 1600 Hz | ∘ | ∘ | ∘ | ∘ |
| | 2000 Hz | ∘ | ∘ | ∘ | ∘ |

The molding substrates of Examples 4 to 6 were excellent in ice peeling property, and therefore, the molding substrates were capable of realizing an exterior material from which adhered snow and ice were easily peeled off.

In addition, from the results of comparing Example 4 with Example 5 and Example 2, it was found that the molding substrate including the fiber base layer having the basis weight larger than that of 800 g/m² was excellent in bending strength and tensile strength in a high-temperature atmosphere.

From the above, it has been found that the present invention can provide a molding substrate capable of realizing an exterior material from which attached snow or ice is easily peeled off.

In addition, it has been found that the molding substrate satisfying the constitution according to the present invention can provide a molding substrate exhibiting the secondary effect capable of realizing an exterior material having excellent sound absorbing performance, sound insulating performance, and stiffness.

### INDUSTRIAL APPLICABILITY

The molding substrate of the present invention can be suitably used as a constituent member of an interior material or an exterior material.

### REFERENCE SIGNS LIST

100, 200: a molding substrate
10, 20: a fiber base layer
11a, 21a: a portion including one main surface of the fiber base layer
11b, 21b: a portion including another main surface of the fiber base material layer
11c, 21c: a portion sandwiched between the portion including the one main surface and the portion including the another main surface of the fiber base material layer

1. A molding substrate comprising a fiber base layer, wherein the fiber base layer includes a core-sheath type conjugate fiber in which a sheath portion is a polypropylene-based resin and a core portion is a polyester-based resin, and a mass percentage of the core-sheath type conjugate fiber in the constituent fibers of the fiber base layer is larger than 70% by mass.

2. The molding substrate according to claim 1, wherein the fiber base layer has a portion (a) including one main surface, a portion (b) including the other main surface, and a portion (c) sandwiched between the portion (a) and the portion (b), and the density of the portion (a) is higher than the density of the portion (c).
